(19) United States
(12) Patent Application Publication
(10) Pub. No.: US 2009/0059748 A1
(43) Pub. Date: Mar. 5, 2009

(54) METHOD, OPTICAL RECORDING APPARATUS USING SUCH METHOD AND OPTICAL RECORDING MEDIUM FOR USE BY THE METHOD AND THE APPARATUS

(75) Inventors: Maarten Van Der Vleuten, Eindhoven (NL); Johannes Hendrikus Maria Spruit, Eindhoven (NL); Derk Jan Adelerhof, Eindhoven (NL); Petrus Adrianus Maria Van Dorst, Eindhoven (NL); Rene Johan Gerrit Elfrink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,244

(22) PCT Filed: Oct. 28, 2005
(86) PCT No.: PCT/IB05/53539

§ 371 Date: Apr. 30, 2007

(30) Foreign Application Priority Data
Nov. 4, 2004 (EP) 04105534.4

(51) Int. Cl. G11B 7/00

(52) U.S. Cl. 369/47.53; G9B/7

(57) ABSTRACT

A method for setting an optimum value of a write power level for use in an optical recording apparatus for writing information on a recording layer (3) of an optical recording medium (1) by means of a radiation beam (5) is described. The recording layer is able to change between an amorphous and a crystalline state. The apparatus comprises a radiation source (4) for emitting the radiation beam (5) having a controllable value of a write power level (P_{w}) for recording information on the recording medium, a control unit (12) for recording a series of test patterns in a test area on the recording layer, each pattern being recorded with a different value of the write power level, a read unit (90) for reading the patterns and forming corresponding read signal portions, and first means (10, 101, 102) for deriving a value of a read parameter from at least one read signal portion and setting an optimum value (Pₒₚₜ) of the write power level based on the values of this read parameter. According to the invention the apparatus further comprises second means to perform at least one initial step (40) of at least partly amorphizing and subsequently recrystallizing the recording layer. In this way a consistent result for the determined optimum value (Pₒₚₜ) of the write power level (P_{w}) is obtained.

The invention relates to a method for setting an optimum value of a write power level of a radiation beam for use in an optical recording apparatus for writing information on a recording layer of an optical recording medium by means of the radiation beam, which recording layer is able to change between an amorphous and a crystalline state, the method comprising a first step of writing a series of test patterns in a test area of the recording layer, each pattern being written using a different value of the write power level (P_{w}) of the radiation beam, a second step of reading the patterns so as to form corresponding read signal portions, and a third step of deriving a value of a read parameter from at least one read signal portion and setting an optimum value (Pₒₚₜ) of the write power level based on the values of this read parameter.

The invention also relates to an optical recording apparatus for writing information on a recording layer of an optical recording medium by means of a radiation beam, which recording layer is able to change between an amorphous and a crystalline state, the apparatus comprising a radiation source for emitting the radiation beam having a controllable value of a write power level (P_{w}) for recording information on the recording medium, a control unit for recording a series of test patterns in a test area of the recording layer, each pattern being recorded with a different value of the write power level, a read unit for reading the patterns and forming corresponding read signal portions, and first means for deriving a value of a read parameter from at least one read signal portion and setting an optimum value (Pₒₚₜ) of the write power level based on the values of this read parameter.

The invention also relates to an optical recording medium for recording information by irradiating a recording layer of the recording medium by means of a radiation beam, the recording medium comprising a test area and an area containing control information indicative of a recording process whereby information can be recorded on said recording medium, the control information comprising values of recording parameters for the recording process. These recording parameters may include parameters indicative of the various power levels but also parameters indicative of timing information.

Rewriteable phase-change media, as used in said method, are initialized during the manufacturing process. This means that the phase change layer is crystallized. Before an optical recording apparatus, for example a drive, starts writing on an optical recording medium, for example an optical disc, generally an optimal power calibration (OPC) is performed to determine the optimum write power level. An OPC can take place on an empty part of the disc (being fully in an initialized crystalline state) or, alternatively, on a part that has been used for one or more OPC's procedures before (and which may therefore be partly in an amorphous state). Because of this, the results of an OPC procedure may vary. Therefore, in conventional OPC-procedures, such as the well-known gamma-OPC-procedure (as described for example in the DVD+ReWritable, 4.7 Gbytes, Basic Format Specifications, System Description, version 1.2, December 2002), a DC-erase has been added to the OPC-procedure, prior to executing the actual OPC. This means that a radiation beam having a DC power level equal to the erase power level is applied. In this way an area being fully in the crystalline state is obtained.

A method and apparatus according to the preamble are known from the European patent application No. EP 0 737 962. The prior art apparatus uses a method that includes the following steps for setting the optimum write power (Pₒₚₜ) of the radiation beam. First the apparatus records a series of test patterns on the recording medium, each pattern with increasing write power (P_{w}). Next, it derives the modulation (M) of each recorded test pattern from the read signal corresponding to the test pattern. It calculates the derivative of the modulation (M) as a function of the write power (P_{w}) and normalizes this derivative by multiplying it by the write power (P_{w}) over the modulation (M). The intersection of the normalized derivative (γ) with a preset value (γ_{target}) determines a target write power level (P_{target}). Finally, this target write power (P_{target}) is multiplied by a parameter rho (ρ) so as to obtain a write power level (Pₒₚₜ) suitable for recording on the recording medium.

The value of the parameter rho (ρ) is read from an area containing control information indicative of a recording process on the recording medium itself. The test patterns are recorded on the recording medium by applying write power (P_{w}) values in a range around a given value (P_{ind}), which is also read from the area containing control information indicative of a recording process on the recording medium itself.

In an optical recording apparatus it is important to record information on optical recording media with the correct power of the radiation beam, such as a laser beam. A media manufacturer cannot give this correct power in an absolute way (for example, pre-recorded on the disc) because of environment and apparatus-to-apparatus deviations for every recording medium and recording apparatus combination.

Other known methods are described in US 2002-0114235-A1 (PHNL000685), U.S. Pat. No. 5,978,351 (PHN16186) and US 2004-0081046-A1 (PHN16187), which are hereby incorporated by reference.

For all known 8× DVD+RW discs it is observed that the results of an OPC-procedure performed on an empty part of the disc is different from the results of an OPC-procedure performed on an previously written part of the same disc. Therefore, with conventional OPC-procedures the determined value of the optimum write power level is dependent on whether or not a previously written OPC-area has been used by the drive. Therefore, the result of the OPC-procedure may be inconsistent.

It is an object of the present invention to provide a method according to the opening paragraph that provides a consistent result for the determined optimum value (Pₒₚₜ) of the write power level (P_{w}).

This object is achieved according to the present invention when the method set forth in the preamble is characterized in that the method further comprises at least one initial step, prior to the first step, of at least partly amorphizing the recording layer and subsequently recrystallizing the recording layer.

The inventors have had the insight that for conventional materials, such as applied for example in 1-2.4× DVD+RW media, a DC-erase as described earlier is a melt-erase. This means that not only amorphous areas are crystallized, but crystalline areas in between these amorphous areas are first melted and are subsequently crystallized. As a result the actual OPC always takes place over fresh, fully crystalline material.

Inventors have had the further insight that in contrast for faster speeds and faster phase-change materials, such as applied for example 8× DVD+RW, recording at higher speeds, for example at 6× and 8×, is done with a non-melt erase. As a result a DC erase prior to the actual OPC will only crystallize the amorphous areas. The already crystalline areas in between the amorphous areas are not melted but will remain in the same crystalline state.

Therefore, when a conventional OPC procedure is executed over an empty, unwritten part of the disc, the actual OPC procedure takes place over aged crystalline material. However, if the same OPC procedure takes place on an already written part of the disc, part of the OPC procedure will be executed over fresh crystalline material (that is, the material which was amorphous before the DC-erase), and part over aged crystalline material (that is, the material which was crystalline before the DC-erase).

Therefore, with conventional OPC-procedures the OPC-results on an empty part can be very different from the OPC-results on a written part. (even up to more then 5% deviation in the optimum value of the write power level). The basic idea of the present invention is that an OPC-procedure should only be applied on a part of the OPC-area having, at least partly, fresh crystalline material. To ensure this a method according to claim 1 is provided. Further embodiments of the method according to the invention are described in the dependent claims.

In an embodiment of the method according to the invention the initial step is performed in a portion of the test area where the first, second, and third step are performed. For example, a drive writes only to the area on which it is going to perform an OPC procedure, prior to executing every OPC procedure, with a safe best guess for the write power.

In further embodiments of the method according to the invention the initial step is repeated in a portion of the test area where the first, second, and third step were not performed, or the initial step is performed in the whole test area or substantially the whole test area. For example, a drive writes the whole OPC-area when encountering an empty unused disc or a disc with a partly unwritten OPC-area. This has the advantage that when the same disc is inserted in the drive a second time, no additional action has to be taken by the drive.

The initial step may comprise the writing of data, a DC erase procedure, or a pulsed erase procedure. An example of such an initial step is a DC erase with a relatively high erase power such that new crystalline material is obtained.

Usually the initial step is performed by means of the radiation bean of an optical recording apparatus, such as for example an optical drive.

Alternatively, the initial step is performed during the manufacturing process of the optical recording medium. This has the advantage that drives which do not yet incorporate the method according to the present invention can successfully write data onto such an optical recording media (that is, with an accurate optimum value of the write power level as obtained by a prior art OPC procedure).

It is a further object of the present invention to provide an apparatus according to the opening paragraph that provides a consistent result for the determined optimum value (Pₒₚₜ) of the write power level (P_{w}).

This object is achieved according to the present invention when the apparatus set forth in the preamble is characterized in that the apparatus comprises second means for performing at least one initial step of at least partly amorphizing the recording layer and recrystallizing the recording layer prior to the first step.

In an embodiment of the apparatus according to the invention the initial step is performed by means of the radiation beam.

It is a further object of the present invention to provide an optical recording medium on which an OPC procedure can be reliably performed.

This object is achieved according to the present invention when the optical recording medium set forth in the preamble is characterized in that at least one initial step of, at least partly, amorphizing the recording layer and recrystallizing the recording layer has been applied to the recording medium. Preferably said at least on initial step has been performed in the test area of the recording medium.

The objects, features and advantages of the invention will be apparent from the following more specific descriptions of examples of embodiments of the invention, as illustrated in the accompanying drawings where:

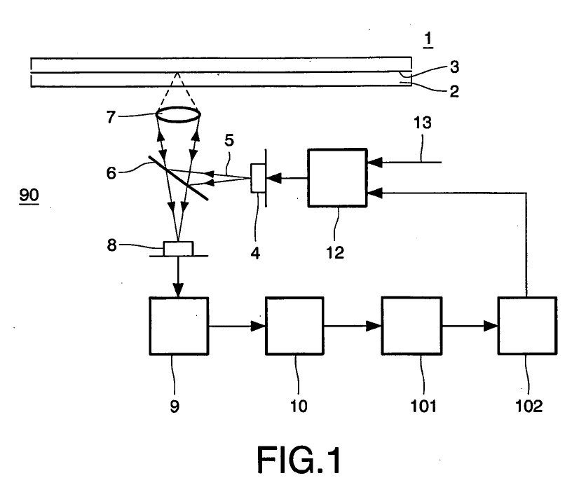

FIG. 1 is a diagram of an embodiment of an optical recording apparatus according to the invention,

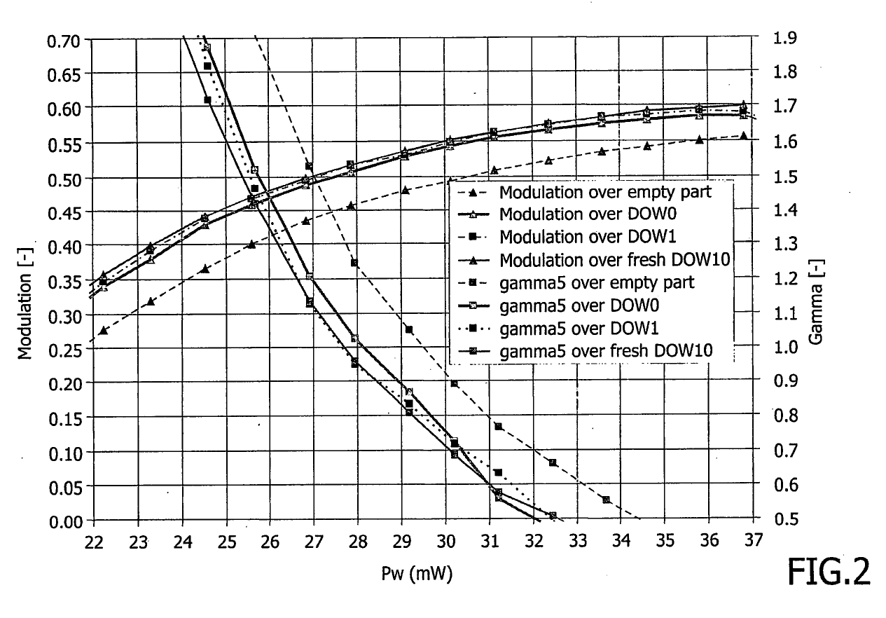

FIG. 2 shows graphs of the modulation and the gamma value as a function of the write power, obtained on material with different conditions prior to the actual OPC,

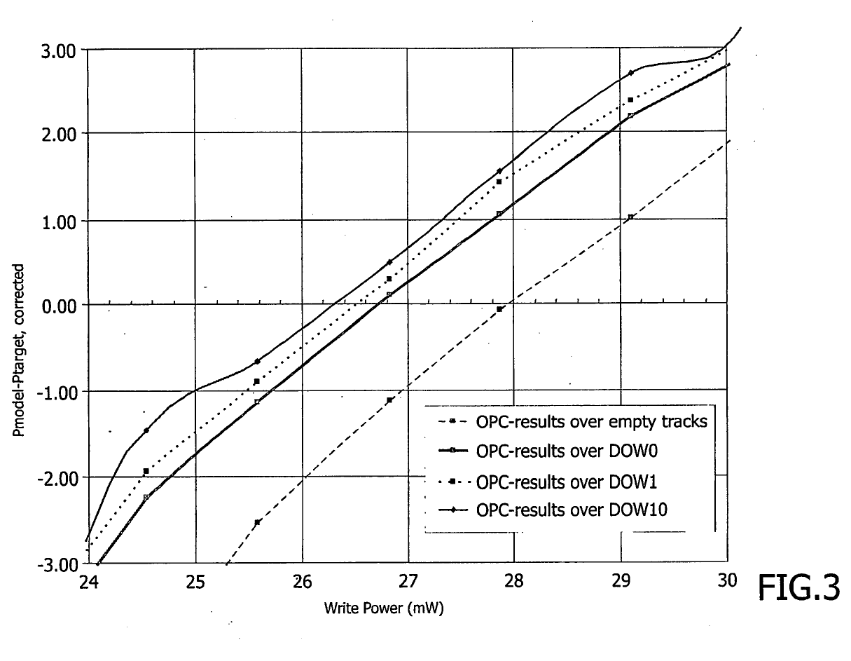

FIG. 3 shows graphs of the actual OPC results, which are obtained on material with different conditions prior to the actual OPC,

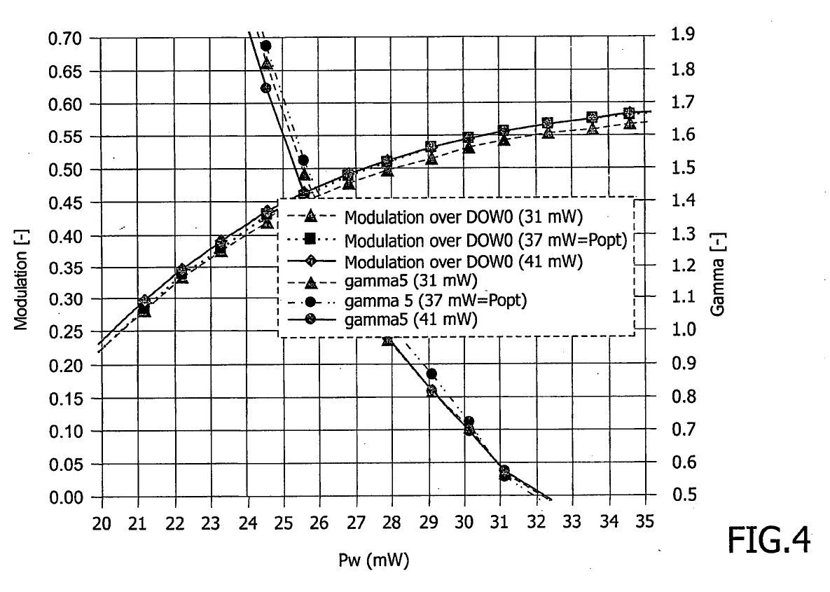

FIG. 4 shows graphs of the modulation and the gamma value as a function of the write power obtained after an initial write with a varying write power,

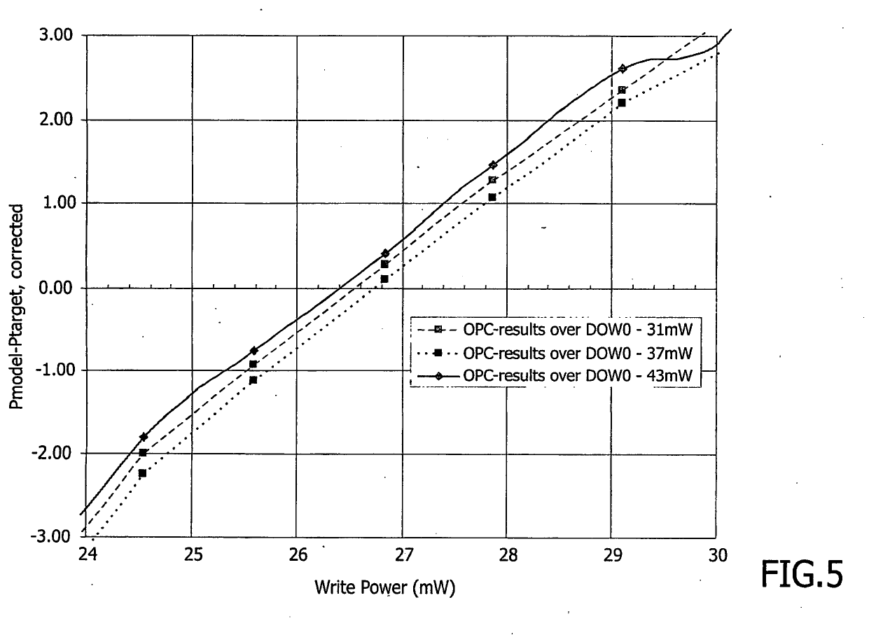

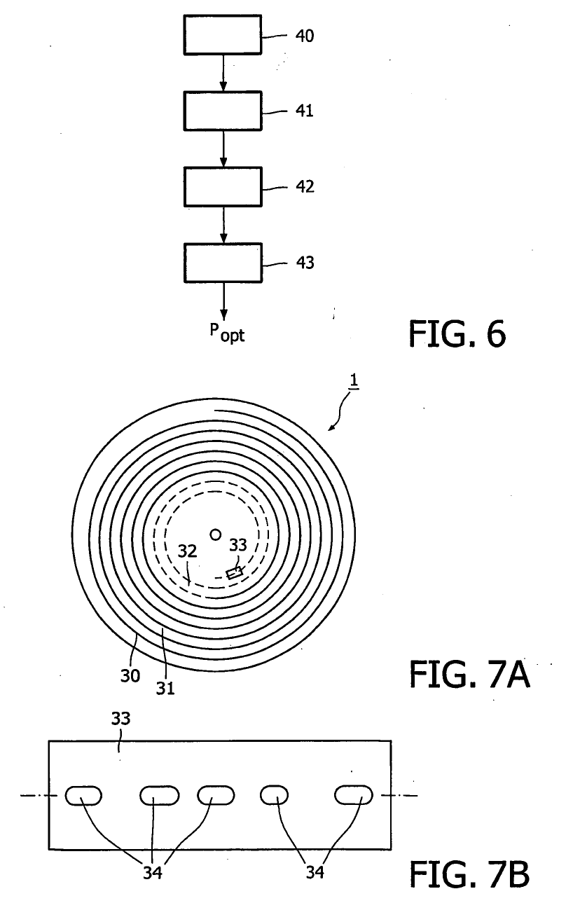

FIG. 5 shows graphs of the actual OPC results which are obtained after an initial write with a varying write power, FIG. 6 is a flow chart of an embodiment of the method according to the invention, and

FIGS. 7A and 7B show an embodiment of a recording medium according to the invention.

FIG. 1 shows an optical recording apparatus according to the invention for recording on an optical recording medium 1. The recording medium 1 has a transparent substrate 2 and a recording layer 3 arranged on it. The recording layer 3 comprises a material suitable for recording information by means of a radiation beam 5. The recording material may be of, for example, the phase-change type, or of any other material. Information may be recorded in the form of optically detectable regions, also called marks, on the recording layer 3. The apparatus comprises a radiation source 4, for example a semiconductor laser, for emitting the radiation beam 5. The radiation beam is converged on the recording layer 3 via a beam splitter 6, an objective lens 7 and the substrate 2. The recording medium may alternatively be air-incident, the radiation beam then being directly incident on recording layer 3 without passing through a substrate 2. Radiation reflected from the medium 1 is converged by the objective lens 7 and, after passing through the beam splitter 6, falls on a detection system 8 that converts the incident radiation in the electric detector signals. The detector signals are applied to a circuit 9. The circuit 9 derives several signals from the detector signals, such as a read signal S_{R} representing the information being read from the recording medium 1. The radiation source 4, the beam splitter 6, the objective lens 7, the detection system 8, and circuit 9 together form a read unit 90.

The read signal from the circuit 9 is processed in a first processor 10 in order to derive signals representing a read parameter from the read signal. The derived signals are fed to a second processor 101 and subsequently to a third processor 102 which processors process a series of values of the read parameter and derive there from a value for a write power control signal necessary for controlling the laser power level.

The write power control signal is applied to a control unit 12. An information signal 13, representing the information to be recorded on the recording medium 1, is also fed to the control unit 12. The output of the control unit 12 is connected to the radiation source 4. A mark on the recording layer 3 can be recorded by a single radiation pulse, the power of which is determined by the optimum write power level (Pₒₚₜ) as determined by the processor 102. Alternatively, a mark can be recorded by a series of radiation pulses of equal or different length and one or more power levels determined by the write power control signal.

A processor is understood to mean any means suitable for performing calculations, for example a microprocessor, a digital signal processor, a hard-wired analog circuit, or a field programmable circuit. Moreover, the first processor 10, the second processor 101 and third the processor 102 may be separate devices or, alternatively, may be combined into a single device executing all three processes.

When an apparatus according to an embodiment of the invention before recording information on the recording medium 1 uses an initial OPC step of writing of data and subsequently erasing said data, prior to the actual OPC steps, the apparatus sets its write power (P_{w}) to a safe best guess value (for example, P_{ind}*rho (ρ); the parameters P_{ind} and rho (ρ) being read from an area containing control information indicative of a recording process on the recording medium itself). One of the ways according to the present invention to avoid inconsistent OPC-results is, for example, to do an initial write and subsequent DC-erase prior to the actual OPC steps.

It is noted that the initial step of writing of data and the subsequent erasing of said data may be performed under the control of the control unit 12, or, alternatively, under the control of an additional control unit (not shown in FIG. 1).

In FIGS. 2 and 3 it is shown that, by applying one, or even better two, initial writes an OPC-result is obtained that is close to the OPC-result obtained when the OPC procedures is performed over a DOW10-written part. Therefore a consistent OPC-result can be obtained on both empty and written parts. DOW means Direct OverWrite (that is, directly writing over a previously written part without a preceding step of erasing the previously written part) and the number represents the number of times a DOW cycle is performed.

In both figures the results of an OPC-procedure over an empty part, without applying an initial write, is plotted also for reference purposes. Those lines, in fact, represent the conventional OPC-procedure over an empty part of the recording medium. Clearly it results in much higher powers than an OPC-procedure over written tracks. In FIG. 2 it can be seen that the modulation (M) and the gamma-curve are very different in case an OPC is applied over an empty part versus an OPC applied over a DOW10 part. By applying an initial step of one initial write before the gamma-OPC (OPC over DOW0), the modulation and the gamma-curves resemble much more the DOW10 situation. Applying an initial step of two initial writes before the gamma-QPC (OPC over DOW1) is even better for a consistent OPC-result.

FIG. 3 shows graphs of the actual OPC results, which are obtained on materials with different conditions prior to the actual OPC. For each different condition the actual P_{target} is the writing power at which the graph crosses the x-axis. Pₒₚₜ is obtained by multiplying P_{target} by a factor rho (ρ) that may be read from the recording medium. In the case of one or more initial writes the difference in P_{target} is smaller than 0.5 mW. In the case no initial write is used, a P_{target} is obtained which has a much too high value.

When a drive performs, in an initial step prior to the actual OPC steps, an initial write, it is not known whether or not it writes with the optimum write power. Therefore the invention was also tested with an initial writing power and DC-erase power of 15% lower than P_{W} and of 15% higher than P_{w} (that is, a write power which is 15% lower than nominal and which is 15% higher than nominal). The results are shown in FIGS. 4 and 5.

In FIG. 4 the OPC results over DOW0 (=initial write) written with three different powers are shown. The modulation- and gamma-curves for these three power levels are much alike. In FIG. 5 it is shown that the difference in OPC-results obtained with different write and erase powers in the initial step is less than 0.5 mW. For each different condition the optimum writing power is the write power at which the graph crosses the x-axis.

In FIG. 6 an embodiment of the method according to the invention is schematically depicted in a flow-chart. In a first step 41, executed after an initial step 40, the apparatus writes a series of test patterns on the medium 1. The test patterns should be selected so as to give a desired read signal. If the read parameter to be derived from the read signal is the modulation (M) of a read signal portion pertaining to a test pattern, the test pattern should comprise marks sufficiently long to achieve a maximum modulation of the read signal portion. This modulation (M) is computed from the following expression

M=((I_{H}−I_{L})/I_{H})·100%,

where I_{H} is the highest level of the amplitude and I_{L} is the lowest level of the amplitude in the read signal derived from reading information recorded on the information carrier comprising longer marks such as, for example, marks having a length of 14 times the channel bit length when Eight-to-Fourteen Modulation Plus (EFM+) coding is employed. When the information is coded according to the so-called Eight-to-Fourteen Modulation (EFM), the test patterns preferably comprise the long I11 marks of the modulation scheme. Each test pattern is recorded with a different write power level (P_{w}). The range of powers can be selected on the basis of an indicative power level (P_{ind}) recorded as control information on the recording medium. Subsequent test patterns may be recorded with a step-wise increased write power level (P_{w}) under the control of the control unit 12. The test patterns may be written anywhere on the recording medium. Alternatively, they can be written in specially provided test areas on the recording medium.

In a second step 42 the recorded test patterns are read by the read unit 90 so as to form a read signal S_{R}. Test patterns may comprise a few hundred marks of different or equal length.

In a third step the 43 processor 10 derives from the read signal S_{R} a read parameter for each read signal portion. A preferred read parameter is the modulation (M). From these read parameters the optimum write power level (Pₒₚₜ) is determined.

According to the invention an initial step 40, executed prior to the first step 41, of at least partly amorphizing the recording layer and recrystallizing the recording layer is performed.

It is preferred to perform the initial step 40 at least once in the Drive Test Zone and the Disc Test Zone before using these areas, in order to increase the reliability of the OPC results. The initial step 40 comprises, for example, recording these test zones with random data and subsequently erasing this recorded data. In such an initial step 40 the following power settings derived from the area containing control information indicative of the recording process (also called Physical format information) may, for example, be used: Write power (Pw)=ρ×P_{ind}, and Erase power (Pe)=ε₁×Pw. Alternatively some optimum write power settings determined by the drive may be used.

FIG. 7A shows an embodiment of a recording medium 1 according to the invention provided with a track 30. The track may have a circular or spiral shape and be in the form of, for example, an embossed groove or ridge. The area of the recording medium 1 is divided in an information recording area 31 for recording user information and a test area 32, also called control area, for testing certain recording parameters and in general not intended for recording user information. The test area 32 is marked by a dashed track in FIG. 7A. The information recording area 31 is of a type that is subject to change with regard to an optically detectable property when exposed to radiation beyond a specific write power level. Information on the recording medium is represented by patterns of optically detectable marks 34.

Information is recorded in a track 30 in the information recording area 31 by a recording process in which each mark 34 is formed by one ore more recording pulses of constant or varying write power in dependence on, for example, the length of the marks to be recorded. The recording parameters for this recording process are tested in the test area 32 in the form of test patterns of marks 34 simulating the recording process. FIG. 7B shows a strongly enlarged portion 33 of the track 30 comprising an example of a test pattern of marks 34. Before the information regarding the recording parameters is tested in a portion of the test area 32, a method according to the invention is performed with an optical recording apparatus according to the invention in the same portion of the control area 32. Alternatively the method according to the invention may be performed in the whole control area 32.

### Applications of the Invention:

the present invention can be implemented in the manufacturing process of phase change type optical media;
The present invention can be implemented in optical drives which record on phase change type optical media, such as DVD-writers, CD-writers, Blu-ray Disc (BD)-writers and HD-DVD writers.

It should be noted that the above mentioned versions and embodiments illustrate rather than limit de invention, and that those skilled in the art will be able to design alternatives without departing from the scope of the appended claims. For example, the invention has been explained on the basis of embodiments using the read signal modulation (M) as read parameter and a disc shaped recording medium. However, it will be clear to a person skilled in the art that alternative read parameters and other shapes of the recording medium can be employed. The jitter of the read signal can, for example, alternatively be used as a read parameter. Moreover, any reference sign placed between parentheses in the claims shall not be construed as limiting the claim. The word “comprise” and its conjugations do not exclude the presence of steps or elements other than those listed in the claims.

1-16. (canceled)

17. A method for setting an optimum value of a write power level for use in an optical recording apparatus for writing information on a recording layer (3) of an optical recording medium (1) by means of a radiation beam (5), which recording layer is able to change between an amorphous and a crystalline state,
the method comprising a first step (41) of writing a series of test patterns in a test area of the recording layer, each pattern being written with a different value of the write power level (P_{w}) of the radiation beam,
a second step (42) of reading the patterns so as to form corresponding read signal portions, and
a third step (43) of deriving a value of a read parameter from at least one read signal portion and setting an optimum value (Pₒₚₜ) of the write power level based on the values of this read parameter,
characterized in that the method further comprises at least one initial step (40) prior to the first step of at least partly amorphizing the recording layer and subsequently recrystallizing the recording layer, and in that said initial step is performed in a portion of the test area where the first and second step are to be performed.

18. A method as claimed in claim 17, wherein the initial step is repeated in a portion of the test area other than the portion of the test area where the first and second step were performed.

19. A method as claimed in claim 17, wherein the initial step is performed in the whole test area, or at least substantially the whole test area.

20. A method as claimed in claim 17, wherein, in the initial step, the at least partly amorphizing of the recording layer and the subsequent recrystallizing of the recording layer are obtained by applying the radiation beam (5) to the recording layer (3).

21. A method as claimed in claim 20, wherein the initial step comprises the writing of data and the subsequent erasing of said data.

22. A method as claimed in claim 17, wherein the initial step comprises a DC erase procedure.

23. A method as claimed in claim 17, wherein the initial step comprises a pulsed erase procedure.

24. A method as claimed in claim 17, wherein the initial step is performed during the manufacturing process of the optical recording medium.

25. A method as claimed in claim 17, wherein, in the initial step, the at least partly amorphizing of the recording layer is obtained during the manufacturing process of the optical recording medium, and the subsequent recrystallizing of the recording layer is obtained during use of the optical recording medium.

26. An optical recording apparatus for writing information on a recording layer (3) of an optical recording medium (1) by means of a radiation beam (5), which recording layer is able to change between an amorphous and a crystalline state, the apparatus comprising
a radiation source (4) for emitting the radiation beam (5) having a controllable value of a write power level (P_{w}) for recording information on the recording medium,
a control unit (12) for recording a series of test patterns in a test area of the recording layer, each test pattern being recorded with a different value of the write power level,
a read unit (90) for reading the patterns and forming corresponding read signal portions, and
first means (10, 101, 102) for deriving a value of a read parameter from each read signal portion and setting an optimum value (Pₒₚₜ) of the write power level based on the values of this read parameter,
characterized in that the apparatus comprises second means (12) for performing at least one initial step (40) prior to the recording of the series of test patterns of at least partly amorphizing the recording layer and subsequently recrystallizing the recording layer.

27. An apparatus as claimed in claim 26, wherein the second means are arranged for the writing of data in order to at least partly amorphizing the recording layer, and are further arranged for subsequently erasing said data in order to subsequently recrystallizing the recording layer.

28. An apparatus as claimed in claim 27, wherein the data is random data.

29. An optical recording medium (1) comprising a recording layer (3), which recording layer is able to change between an amorphous and a crystalline state, for recording information by irradiating the recording layer by means of a radiation beam (5), the recording layer comprising a test area (32) and an area containing control information indicative of a recording process whereby information can be recorded on said recording medium, the control information comprising values of recording parameters for the recording process,
characterized in that at least a part of the recording layer has an amorphous state.

30. An optical recording medium (1) comprising a recording layer (3), which recording layer is able to change between an amorphous and a crystalline state, for recording information by irradiating the recording layer by means of a radiation beam (5), the recording layer comprising a test area (32) and an area containing control information indicative of a recording process whereby information can be recorded on said recording medium, the control information comprising values of recording parameters for the recording process,
characterized in that at least a part of the recording layer has an crystalline state, and in that this at least a part of the recording layer in the crystalline state was obtained by amorphizing and subsequently recrystallizing the at least a part of the recording layer.

31. An optical recording medium as claimed in claim 29, wherein the at least a part of the recording layer is located in the test area of the recording medium.
